(19) United States
(12) Patent Application Publication
(10) Pub. No.: US 2006/0141985 A1
(43) Pub. Date: Jun. 29, 2006

(54) Dynamic management for interface access permissions

(75) Inventors: Biren R. Patel, Coral Springs, FL (US); Jyh-Han Lin, Parkland, FL (US); Ronald R. Smith, Coral Springs, FL (US); Ruiqiang Zhuang, Coral Springs, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 11/022,374

(22) Filed: Dec. 23, 2004

(51) Int. Cl. H04M 3/16

(52) U.S. Cl. 455/410

(57) ABSTRACT

A system, device, and method, for managing application interface access permissions for an application (302) in an electronic device, such as a wireless device (104), is disclosed. The method includes associating a security policy with an application (302). The method further includes creating a history log (324) associated with the application (302). The history log (324) includes time information associated with permission information indicating permission for an application to access at least one application interface in the electronic device (104). The method further includes dynamically adjusting the security policy for the application (302) when a security control signal associated with the application (302) is detected.

### CROSS-REFERENCE TO RELATED APPLICATION

The present patent application is related to co-pending and commonly owned U.S. patent application Ser. No. ______, Attorney Docket No. CE13033JSW, entitled “MANAGEMENT OF PERSISTENT SOFTWARE APPLICATIONS”, filed on even date with the present patent application, the entire teachings of which being hereby incorporated by reference.

### FIELD OF THE INVENTION

The present invention generally relates to the field of controlling interfaces for electronic devices, and more particularly relates to interface access permission management for wireless communication devices such as a cellular phone or a smart phone.

### BACKGROUND OF THE INVENTION

Wireless communications devices continue to expand in function and features as wireless technology develops. Digital Rights Management (“DRM”) and camera and video capture are just a few of the capabilities currently being integrated into cellular phones and other wireless devices by using open platforms such as Java. These capabilities allow various types of data to be produced, which are then stored on the wireless device. Applications integrated into the wireless device routinely request access to the stored data. However, unrestricted access to the data may not be available because the data may be classified as protected. Therefore, the applications have predefined security policies that they must follow when requesting access to data.

The use of predefined security policies, although useful, is not without its drawbacks. Currently, users of a wireless device have to manually select a security policy to be applied to an application. Therefore, every time a user wishes to change the security policy for an application, the user, for example, may have to open a menu system and manually select a desired policy. This manual process of selecting a security policy is inefficient and cumbersome because a user will have to manage security policies for many of the applications residing on the wireless device, which is a very tedious and time consuming process.

Another problem is that the user has to decide whether to “trust” an application and select a security policy based upon that decision. Once a user decides to “trust” an application and selects the corresponding security policy, there are no safeguards to prevent the application from performing malicious activities.

Yet another problem is that the user of the wireless device is the one selecting the security policy for the applications. If a user enters into a restricted area such as a research lab, the user is able to select a security policy for an application that may allow the application to record confidential information. The user can then select a security policy that allows an application access to the recorded confidential information for purposes of unauthorized dissemination. This is particularly problematic for a group administration function where different users having different wireless devices may have changing security authorizations for their particular applications on their wireless devices.

Therefore a need exists to overcome the problems with the prior art as discussed above.

### SUMMARY OF THE INVENTION

Briefly, in accordance with the present invention, disclosed are a system, method, and computer program product on a wireless device for managing interface access permissions for at least one application residing on the wireless device such as a wireless messaging device, a personal digital assistant (PDA), and a cellular telephone. The method comprises determining an initial security level for at least a first application and associating a security policy with the at least first application. The security policy is based on the determined security level for the at least first application. The method further comprises creating an event history log associated with the at least first application. The history log includes at least time information and permission to access the at least one interface information. The method further comprises dynamically adjusting the security policy for the at least first application based on receiving at least one security control signal associated with the at least first application.

In another embodiment of the present invention, a wireless device for managing interface access permissions for at least one application residing on the wireless device is disclosed. The wireless device comprises a memory and at least one application. The wireless device further comprises a device controller that is communicatively coupled to the memory. The wireless device further comprises an interface and a device permissions database, both being communicatively coupled to the device controller. The device permissions database is comprised of at least interface access permission information that is associated with the at least one application. The wireless device further comprises a device permissions control module that is communicatively coupled to the device controller and the device permissions database. The device permissions control module dynamically adjusts a security policy for the at least one application based on receiving a security control signal associated with the at least one application.

In yet another embodiment of the present invention, a communications system for managing interface access permissions for at least one application residing on a wireless device is disclosed. The communications system comprises a central communications server and at least one wireless device, both being communicatively coupled to a communications network. The at least one wireless device includes at least a device permissions database and a device permissions control module. The communications system further comprises a central permissions database that is communicatively coupled to the central server and the device permissions database. The central permissions database is comprised of interface access permission information for at least one application residing on the at least one wireless device. The communications system further comprises a central permissions control module that is communicatively coupled to the central communications server, the central permissions database, and the device permissions control module. The central permissions control module dynamically adjusts a security policy that is associated with the at least one application residing on the at least one wireless device for accessing an interface of the at least one wireless device.

An advantage of the foregoing embodiments of the present invention is that the security policy for the at least one application residing on the wireless device is dynamically adjusted by the device without requiring user manual adjustment. This results in a more efficient management of application security policies and a more secure operating environment for the applications.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating a wireless communication system according to an embodiment of the present invention.

FIG. 2 is a block diagram illustrating a wireless device for a wireless communication system according to an embodiment of the present invention.

FIG. 3 is a block diagram illustrating a more detailed view of memory and storage for the wireless device of FIG. 2.

FIG. 4 illustrates an exemplary device permission record according to an embodiment of the present invention.

FIG. 5 illustrates an exemplary application information table according to an embodiment of the present invention.

FIG. 6 illustrates an exemplary event record according to an embodiment of the present invention.

FIG. 7 is a block diagram illustrating a more detailed view of the central server of FIG. 1.

FIG. 8 is a block diagram illustrating an operating system environment with an untrusted application in a managed security area, according to an embodiment of the present invention.

FIG. 9 is an operational flow diagram illustrating dynamic association of permissions with an application.

FIG. 10 is an operational flow diagram illustrating dynamic adjustment of permissions for an application.

FIGS. 11 and 12 comprise an operational sequence illustrating a process of determining permissions for an application and whether permissions for an API may need to be updated.

FIG. 13 is an operational flow diagram illustrating an API access request process according to an embodiment of the present invention.

FIG. 14 is an operational flow diagram illustrating dynamic adjustment of permissions for an API according to an alternative embodiment of the present invention.

FIG. 15 is an operational flow diagram illustrating dynamic adjustment of permissions in response to a remote security signal being received.

FIG. 16 is an operational flow diagram illustrating dynamic adjustment of permissions in response to a data cable being attached to a wireless device.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The present invention, according to an embodiment, overcomes problems with the prior art by providing dynamic management of application interface access permissions for an electronic device. While an electronic device is intended to be broadly covering many different types of devices that operate electronically, for this example the discussion will illustrate aspects of the present invention by discussing a wireless device in a wireless communication system. An electronic device, for example, and not for any limitation, should be understood to include at least any one or a combination of the following: a cellular telephone, a mobile phone, a smartphone, a two-way radio, a wireless device, a wireless messaging device, a PC, a pocket PC, an organizer, and a personal digital assistant. The term wireless device is intended to broadly cover many different types of devices that can wireless receive signals, and optionally can wireless transmit signals, and may also operate in a wireless communications system. For example, and not for any limitation, a wireless device can include any one or a combination of the following: a cellular telephone, a mobile phone, a smartphone, a two-way radio, a two-way pager, a wireless messaging device, and the like.

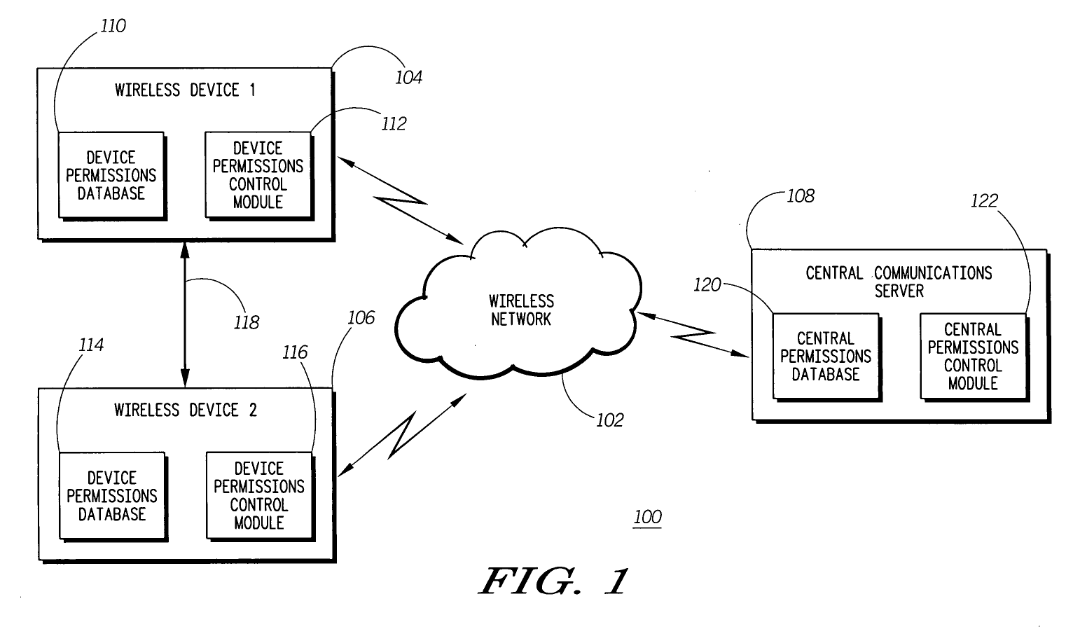

According to an embodiment of the present invention, as shown in FIG. 1, an exemplary wireless communication system 100 comprises a wireless network 102 that connects wireless devices 104, 106 with a central communications server 108. The wireless network 102 comprises at least one of a mobile phone network, a mobile text messaging device network, a pager network, or the like. Further, the communications standard of the wireless network 102 of FIG. 1 comprises Code Division Multiple Access (CDMA), Time Division Multiple Access (TDMA), Global System for Mobile Communications (GSM), General Packet Radio Service (GPRS), Frequency Division Multiple Access (FDMA) or the like.

The wireless network 102 supports any number of wireless devices 104,106 which includes support for mobile telephones, smart phones, text messaging devices, handheld computers, pagers, beepers, or the like. A smart phone is a combination of 1.) a pocket PC, handheld PC, palm top PC, or Personal Digital Assistant (PDA) and 2.) a mobile telephone. More generally, a smartphone is a mobile telephone that has additional application processing capabilities.

Additionally, the wireless devices 104, 106 include device permissions databases 110, 114, respectively. The device permissions databases 110, 114 contain application interface access permission records for applications residing on their respective wireless devices 104, 106. Device permissions control modules 112, 116 are also located in the wireless devices 110, 112, respectively. The device permissions control modules 112, 116 process application interface access permission information and dynamically adjust the application interface access permissions for their respective wireless device 110, 112 accordingly.

The wireless devices 104, 106, in this example, also include a local wireless link 118 that allows the wireless devices 104, 106 to directly communicate with each other and without using the wireless network 102. The local wireless link 118, for example, is provided by Integrated Enhanced Digital Network (iDEN), Bluetooth, Infrared Data Access (IrDA) technologies or the like. The wireless devices 104, 106 are described in greater detail below.

The central communications server 108 maintains and processes information for all wireless devices 104, 106 communicating on the wireless network 102. A central permissions database 120, that is located in the central communications server 108, stores device permissions for each wireless device 104, 106. A central permissions control module 122 located in the central communications server 108, maintains and processes application interface access permissions for all wireless devices 104, 106 on the wireless network. The central communications server 108 will be described in greater detail below.

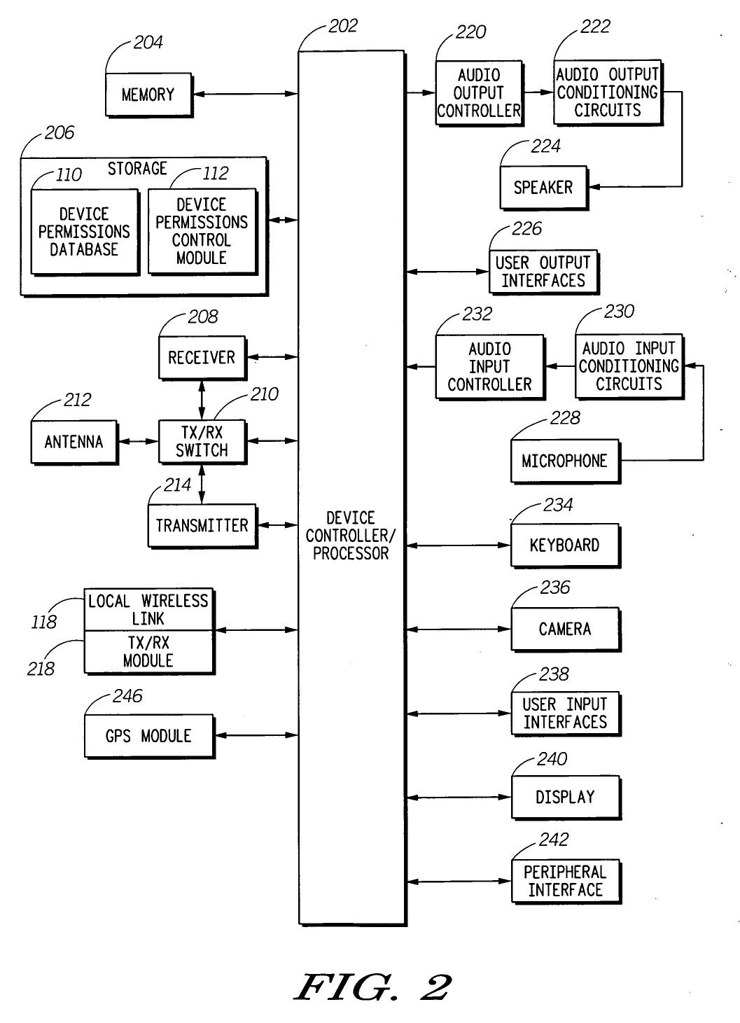

Referring to FIG. 2, a wireless device 102 for a wireless communication system is illustrated. In one embodiment of the present invention, wireless device 106 is a two-way radio capable of receiving and transmitting radio frequency signals over a communication channel under a communications protocol such as CDMA, FDMA, CDMA, GPRS, GSM or the like.

The wireless device 104 operates under the control of a device controller/processor 202, that switches the wireless device 104 between receive and transmit modes. In receive mode, the device controller 202 electrically couples an antenna 212 through a transmit/receive switch 210 to a receiver 208. The receiver 208 decodes the received signals and provides those decoded signals to the device controller 202. In transmit mode, the device controller 202 electrically couples the antenna 212, through the transmit/receive switch 210, to a transmitter 214. The device controller 202 operates the transmitter and receiver according to instructions stored in the memory 204. These instructions include a neighbor cell measurement-scheduling algorithm.

FIG. 2 also includes non-volatile storage memory 206 for storing information such as may be used during the overall process of the present invention as will be discussed below. For example, an application waiting to be executed (not shown) on the wireless device 104 can be stored in the storage memory 206. In an embodiment of the present invention, the device permissions database 110 and the device permissions control module 112 are stored in the storage memory 206.

An exemplary local wireless link 118 comprises iDEN, Bluetooth, IrDA technologies or the like. The local wireless link 118 also includes a local wireless link transmit/receive module 218 that allows the wireless device 104 to directly communicate with another wireless device 106.

The wireless device 104 of FIG. 2 further includes an audio output controller 220 that receives decoded audio output signals from the receiver 208 or the local wireless link transmit/receive module 218. The audio controller 220 sends the received decoded audio signals to the audio output conditioning circuits 222 that perform various conditioning functions. For example, the audio output conditioning circuits may reduce noise or amplify the signal. A speaker 224 receives the conditioned audio signals and allows audio output for listening by a user. The wireless device 104 further includes additional user output interfaces 226, for example, a head phone jack (not shown) or a hands-free speaker (not shown).

The wireless device 104 also includes a microphone 228 for allowing a user to input audio signals into the wireless device 104. Sound waves are received by the microphone 228 and are converted into an electrical audio signal. Audio input conditioning circuits 230 receive the audio signal and perform various conditioning functions on the audio signal, for example, noise reduction. An audio input controller 232 receives the conditioned audio signal and sends a representation of the audio signal to the device controller 202.

The wireless device 104 also comprises a keyboard 234 for allowing a user to enter information into the wireless device 104. The wireless device 104 further comprises a camera 236 for allowing a user to capture still images or video images into memory 204. Furthermore, the wireless device includes additional user input interfaces 238, for example, touch screen technology (not shown), a joystick (not shown), or a scroll wheel (not shown).

A display 240, for example, is also included on the wireless device 104 for displaying information to the user of the wireless device 104. Additionally, FIG. 2 also shows a peripheral interface 242 for allowing the connection of a data cable to the wireless device 104. In one embodiment of the present invention, the connection of a data cable allows the wireless device 104 to be connected to a computer or a printer.

An optional Global Positioning System (GPS) module 244, for example, is also included on the wireless device for determining location and/or velocity information of the wireless device 104. This module 244 uses the GPS satellite system to determine the location and/or velocity of the wireless device 244. Alternative to the GPS module 244, the wireless device 104 may include alternative modules for determining the location and/or velocity of wireless device 104, for example, using cell tower triangulation and assisted GPS.

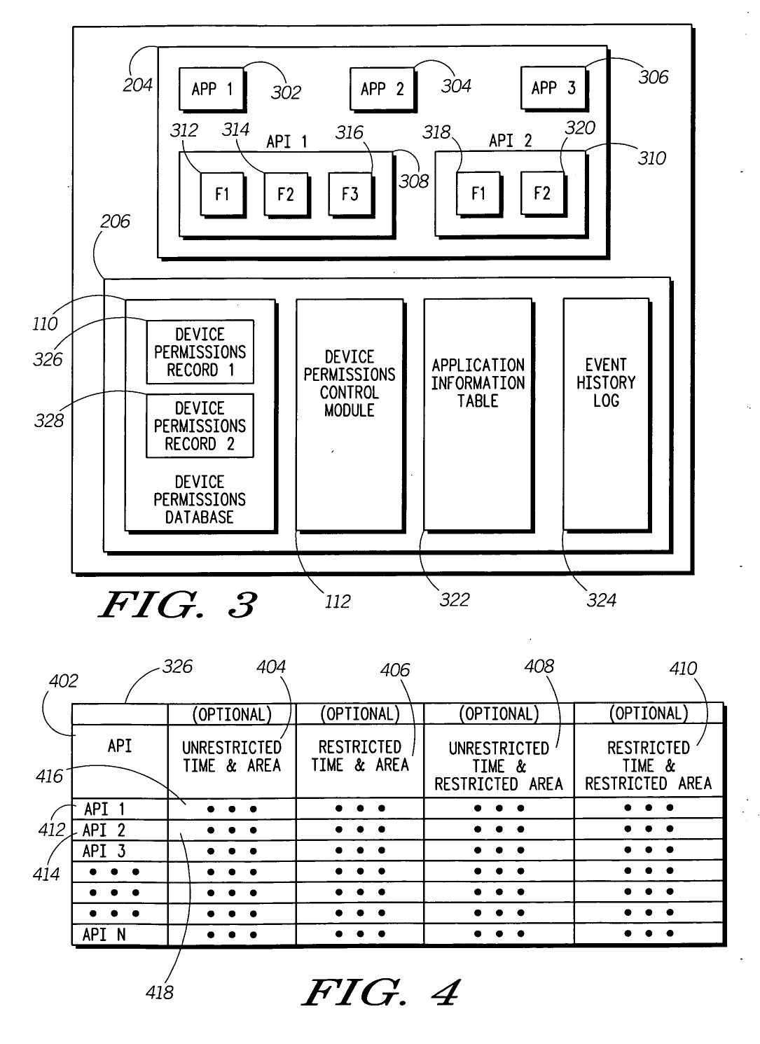

Referring to FIG. 3, an exemplary memory 204 and storage memory 206 of the wireless device 104 is illustrated. The memory 204 comprises volatile memory, for example, Random Access Memory (RAM). In FIG. 3, applications 302, 304, 306 have begun to execute in the memory 204. The applications 302, 304, 306, for example, may be downloaded from a server or a computer; transferred from another wireless device 106; or may be pre-stored in the storage memory 206 of the wireless device 104 and then transferred from storage memory 206 to the memory 204. FIG. 3 also shows two exemplary application interfaces, in this example also referred to as application program interfaces (APIs) 308, 310, residing in the memory 204. It is understood that a smaller or larger number of APIs may be located in the memory 204. The API1 308 includes API functions 312, 314, 316 and API data structures (not shown). The API2 310 includes API functions 318, 320 and data structures (not shown). Additionally, the APIs 308, 310 and their functions 312, 314, 316, 318, 320, for example, are being requested by the applications 302, 302, 306 executing in the memory 204.

An exemplary embodiment of the storage memory 206 comprises the device permissions database 110, the device permissions control module 112, an application information table 322, and an event history log 324. The device permissions database 110 includes device permission records 326, 328. The device permissions records 326, 328 comprise interface access permission information for APIs residing on the wireless device 104. For example, device permissions record1 326 comprises interface access permissions for API1 308, and API2 310. An exemplary device permission record1 326 will be discussed in greater detail below.

The device permissions control module 112, according to the present example, processes interface access control information for the wireless device 104. Interface access control information, for example, may include device permission records; requests from applications to access an API; security update signals, permissions control signals; and/or pointers to permission records; or the like. Additionally, the device permissions control module 112 is, for example, a sub-agent of the device controller 202 and is also controlled by the device controller 202. An exemplary device permissions control module 112 is communicatively coupled to the device controller 202, the device permissions database 110, the application information table 322, and the event history log 324, so that it may dynamically adjust a security policy for an application. The security policy indicates permission for an application to access at least one application interface of the wireless device 104.

The storage memory 206 also comprises the application information table 322 for recording various types of information about applications residing in the wireless device 104. For example, the application information table 322 includes information identifying the name of the application; the location of the application; the security level of the application; and the location of the permissions record that the application is pointing to in the device permissions database 110. The application information table 322 will be discussed in greater detail below.

The event history log 324, in this example, comprises information relating to event occurrences on the wireless device 104. An event occurrence includes, for example, when the APP1 302 creates a data file in storage memory 206. An exemplary event history log will be described in greater detail below. More generally, a history log 324 includes time information associated with permission information, as will be discussed in more detail below.

Referring to FIG. 4, an exemplary device permissions record such as device permission record1 326 according to one embodiment of the present invention is shown. The device permissions record1 326 comprises an API field 402 for listing the APIs residing on the wireless device 104. For example, the two entries 412, 414 exist for the two exemplary APIs 308, 310, shown in FIG. 3. The device permissions record1 326 also includes optional fields 404, 406, 408, 410, as will be discussed below. An embodiment of the present invention, for example, may have only one field for specifying permission for each of the APIs listed in the permissions record1 326.

The first optional field 404 shown in FIG. 4 includes permissions for APIs when the wireless device 104 operates in an unrestricted time period and an unrestricted area. For example, the permissions 416 are used to control access to function1 312 of API1 that processes outgoing calls from the wireless device 104. Similarly, the permissions 418 grant access to function1 318, API2 310 that, for example, processes data to be transferred across a network.

A second optional field 406 includes permission for APIs when the wireless device 104 operates in a restricted time period and a restricted geographic area. A time period may be classified as restricted when certain access to APIs of the wireless device 104 may be restricted, for example, during working hours. A restricted geographic area includes an area where certain access to APIs of the wireless device 104 may be restricted, for example, a research lab, public restroom, or public dressing room. A third optional field 408 includes permissions for APIs when the wireless device 104 operates in an unrestricted time period and a restricted area. A fourth optional field 410 includes permissions for APIs when the wireless device 104 operates in a restricted time period and an unrestricted area.

Additionally, if the permissions data record1 326 includes the optional fields 404, 406, 408, 410, as discussed above, the storage memory 206 further comprises an optional context information table (not shown). The context information table comprises information regarding the operating state of the wireless device 104 with respect to the time period and geographic area. The context information table may also include additional context information for the device 104 and/or a user of the device 104. The table is updated whenever the restrictive state of the time period or geographic area switches from its current state. For example, if the wireless device 104 operates during a restricted time period and a restricted geographic area, the table, for example, includes an entry identifying this as the current state of the wireless device 104. If the time period or geographic area becomes unrestricted, the table gets dynamically updated to reflect this as the new current state of the wireless device 104.

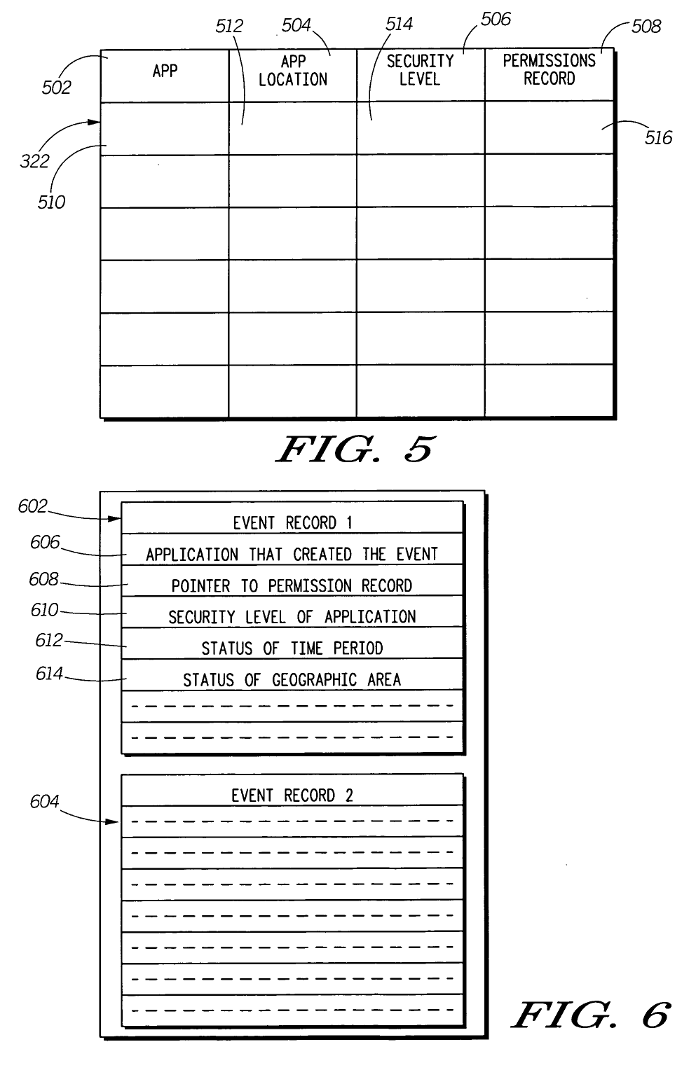

Referring to FIG. 5, an exemplary application information table 322, according to an embodiment of the present invention is illustrated. The application information table 322 includes an application field 502, an application location field 504, a permission record field 506, and a security level field 508. The application field 502 comprises an entry 510 for each application residing on the wireless device 104. For example, in one embodiment of the present invention entry 510 identifies a camera application. The application location field 504 comprises an entry 512 with a pointer pointing to the location in the storage memory 206 where is stored the application identified by the application entry 510. For example, the application location entry 512 includes a pointer to the location of the camera application in the storage memory 206.

Additionally, the permission record field 508 comprises an entry 516 with a pointer pointing to the permissions record residing in the device permission database 110 associated with the application identified in the application entry 510. For example, the permissions record entry 516 includes a pointer to the device permissions record1 326 residing in the device permissions database 110. The security level field 506 comprises a security level entry 514 that associates the application in the application entry 510 with a certain security level. For example, the security level entry 514 identifies the security level of the camera application as trusted, or alternatively as untrusted.

Referring to FIG. 6, a more detailed view of the event history log 324 of FIG. 3 according to an embodiment of the present invention is illustrated. The event history log 324 comprises event records 602, 604. The event records 602, 604 exist for every event that occurs on the wireless device 104. In an exemplary embodiment of the present invention, an event includes data being created by an application and stored in storage memory 206. The event record1 602 includes an application entry 606, that identifies the application associated with the event. The event record1 602 also includes a pointer entry 608 that points to the permissions record that the application was associated with when the event was created. For example, if the application is associated with an event and is pointing to the permissions record1 326 at the time of the event, the pointer 606 also points to permissions record1 326.

The event record1 602 also includes a security level entry 610 for identifying the security level of the application at the time of the event. For example, if the application creates an event and has a security level of trusted, the entry 610 will identify this as the current security level. The event record1 602 further may include a time period status entry 612, that identifies whether the event occurred during a restricted or unrestricted time period. Additionally, the event record1 326 also may include a geographic area status entry 614, that identifies whether the event occurred while the wireless device 104 was operating in a restricted or unrestricted geographic area.

An exemplary implementation of the event history log will now be described. A user of the wireless device 104 uses a camera application to take a picture. A picture image file is created and stored in the storage memory 206. The camera application was pointing to the permissions record1 326 at the time the picture file was created and stored in the storage memory 206. Additionally, the wireless device was operating in a restricted time period and a restricted geographic area when the picture image file was created. The creation of a file in storage memory 206 is an event and an event record1 502 is created in the event history log 324. An application entry 606 is created in the event record 602 identifying the camera application as the application that created the picture file stored in the storage memory 206. A pointer entry 608 is created that points to the permissions record1 326. The security level of the camera application at the time of the event was untrusted and is recorded in the security level entry 610. The time period status entry 612 identifies the status as restricted and the geographic area status entry 614 identifies the status as restricted.

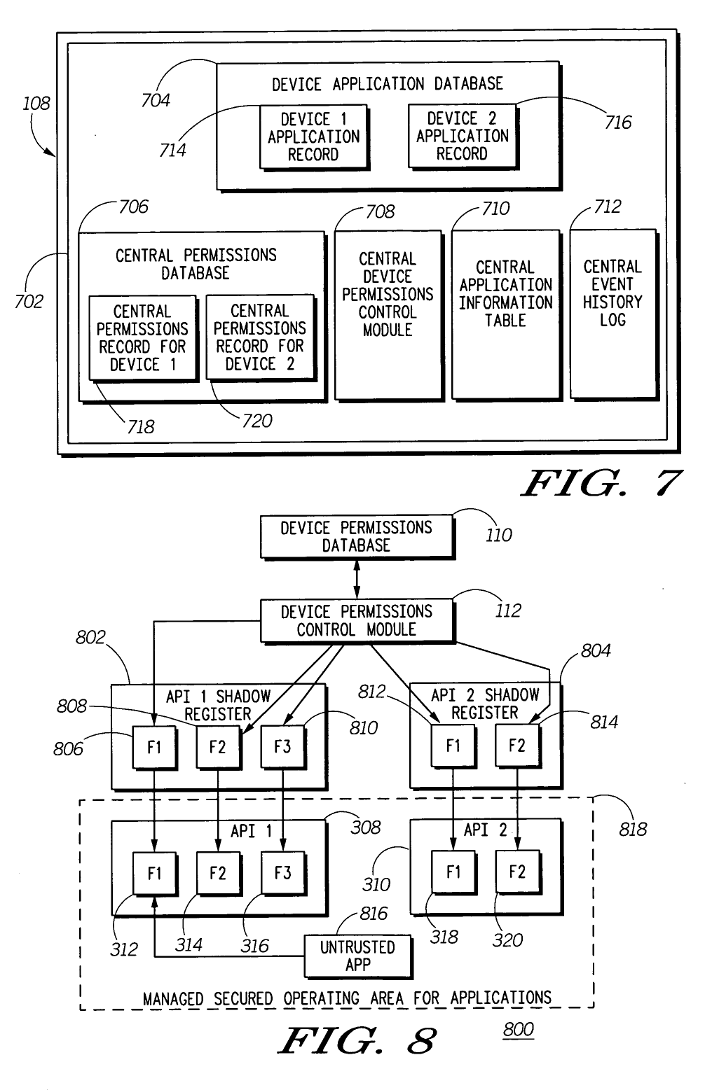

Referring to FIG. 7, a more detailed view of the central server 108 is illustrated. The central server comprises a storage memory 702 and a device application database 704 for recording all applications residing on each wireless device 104, 106 operating in the wireless network 102. For example, the device application database 704 includes a device application record 714, 716 for each wireless device 104, 106. The application record1 714 includes a list of each application residing on the wireless device 104.

The central server 108 also comprises a central permissions database 706 similar to the device permissions database 110 discussed above with reference to FIG. 3. However, the central permissions database 706 comprises a central permissions record 718, 720 for each wireless device 104, 106 operating on the wireless network 102. The central permissions records 718, 720 include the permission records 326, 328 for each wireless device 104, 106.

The central server 108 further comprises a central permissions control module 708 for processing permission information for each wireless device 104, 106. An exemplary central permissions control module is communicatively coupled to the central permissions database 706, the central application information table 710, and the central event history log 712 so that it may dynamically adjust a security policy for an application residing on a wireless device 104, 106.

Additionally, the central server 108 includes a central application information table 710. The central application table 710 includes information similar to the application information table 322, as discussed above with reference to FIG. 5. However, the central application information table 710 includes separate for wireless device 104, 106 operating on the wireless network 102. The central server 108 also may include a central event history log 712 for recording events created on each wireless device 104, 106. The central event history log 712 includes information similar to the event history log 324, as discussed above with reference to FIG. 6. However, the central event history log includes records for each wireless device 104, 106.

One of the advantages of the central server 108 and its above components is that the permissions information for a wireless device can be processed outside of the wireless device. This creates more processing power for the wireless device and available memory. Additionally, the permissions can be updated, for example, by a system administrator from a remote site.

Referring to FIG. 8, a block diagram illustrating an exemplary embodiment of the present invention is shown. The device permission database 110, in this example, includes interface access permissions for API1 308 and API2 310. The device permissions control module dynamically updates an API shadow register 802, 804 corresponding to an API 308, 310 with the appropriate permission information. For example, the device permissions control module 112, dynamically updates the API1 shadow functions 806, 808, 810 located in the API1 shadow register 802 with the permissions associated with the API1 308.

An untrusted application 816 operates in a managed secured operating area 818. The managed secured operating area prevents the untrusted application from gaining access to unauthorized APIs and their functions. The untrusted application 816 requests access to API1 308 and API2 310. More specifically, the untrusted application requests access to function1 312 of API1 308 and function2 320 of API2 310. The APIs 308, 310 communicate with their respective API shadow registers 802, 804 to check whether the requesting untrusted application 816 has access to the APIs 308, 310. The API shadow registers 802, 804 communicate back to the APIs 308, 310 with the requested information and access to the APIs 308, 310, for example, is either granted or denied.

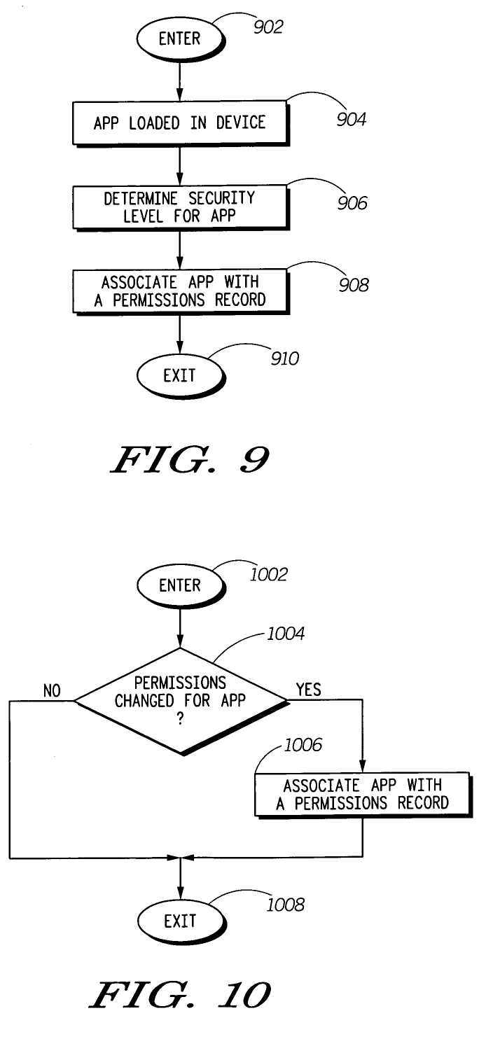

Referring to FIG. 9, an operational flow diagram shows an exemplary process of how the wireless device 104, central communications sever 108, computer readable medium, or any other electronic device, associates interface permissions with an application residing on the wireless device 104. The operational flow diagram of FIG. 9 begins with step 902 and flows directly to step 904.

An application, at step 904, loads into the wireless device 104. For example, an application may be downloaded from the Internet or the central server 108 onto the wireless device 104. Additionally, the application may be transferred from a computer or another electronic device to the wireless device 104. The application comprises information including a security level identifier and a pointer to a permissions record 326 in the device permissions database 110. The security level identifier, for example, identifies the security level of the application as trusted or untrusted.

Once the application is loaded into the wireless device, at step 904, the device controller 202 by one of its sub-components, for example, the device permissions control module 112 processes the information included with the application. The device permissions control module 112 dynamically updates the application information table 322 (see FIG. 5) with the identity of the application and the location of the application. For example, if the application loaded in to the wireless device, at step 904, is a camera application, the device controller 202 creates the application entry 510 in the application field 502 of the application information table 322 (see FIG. 5) and identifies the camera application. Next, the device controller 202 creates the application location entry 512 in the application location field 504 comprising a pointer to the location of the camera application in the storage memory 206.

The device permissions control module 112, at step 906, determines the security level for the application. The device permissions control module 112 processes the security level identifier information included with the application and updates the application information table 322. For example, if the camera application includes a security identifier identifying the security level as untrusted, the device permissions control module 112 creates the entry 514 in the permissions record field 506 that identifies the security level of the camera application as untrusted.

The device permissions control module 112, at step 908, associates the application with a permissions record residing in the device permissions database 110. The device permissions control module 112 processes the permissions record pointer information included with the application and updates the application information table 322. For example, the device permissions control module 112 creates the entry 516 under the permissions record field 508 with the permissions record1 326 pointer information. Once a permissions record is associated with the application at step 908, the control flow, at step 910, exits.

One advantage of an embodiment of the present invention is that the permissions and the security level of applications residing on the wireless device 104 are recorded and automatically tracked. This results in the applications being managed more securely and without the need of user intervention. Furthermore, the recording and tracking of the permissions and security levels of the applications facilitates the dynamic adjustment of the permissions and security levels.

Referring to FIG. 10, an operational flow diagram showing an operational sequence for dynamically updating the permissions associated with an application is illustrated. The operational flow diagram of FIG. 10 shows an overall process of how the device controller 202 by one of its sub-components, the permissions control module 112, determines whether the permissions for an application have changed. This process is generally represented by the permissions control module 112 detecting a permissions control signal. The device permissions control module 112, in this example, continuously performs the operational sequence shown in FIG. 10 at set intervals of time. The operational flow diagram of FIG. 10 begins with step 1002 and flows directly to step 1004.

The device permissions control module 112, at step 1004, determines whether the permissions for the application have changed (e.g., detection of a permissions control signal). The application may be an application residing in the storage memory 206 or an application 302 already executing in the memory 204. In an exemplary embodiment of the present invention, the permission record that is associated with the application is dependent upon the security level of the wireless device 104. For example, if the security level for the executing application is untrusted, the permission record associated with the application is different than if the application is trusted.

The device permissions control module 112 refers to the application information table 322 and determines whether the security level of the application has changed. That is, the device permissions control module 112 determines a detection of a permissions control signal. The security level of an application can change, for example, by receiving a security signal (or a permissions control signal) from the central server 108. If the result of this determination is positive, the control flows to step 1006. If the result of this determination is negative, the control flows to step 1008 and exits.

The device permissions control module 112, at step 1006, dynamically updates the permissions record associated with the application according to the new security level. The device permissions control module 112 then dynamically updates the application information table 322 with the new information associated with the application. For example, if the pointer information to the permissions record has changed, the application information table 322 is updated. The control flow, at step 1008, then exits. In this example, the device permissions control module 112 dynamically adjusts a security policy for at least one application in the wireless device 104 in response to detecting at least one interface permission control signal. The at least one interface permission control signal, according to the present example, includes at least one of: detecting a transition for the wireless device between a restricted area and an unrestricted area, detecting a transition for the wireless device between a restricted time and an unrestricted time, detecting that an application is requesting access to stored application data; detecting whether an interface cable is connected to the wireless device; and receiving a wireless communication signal from a central server.

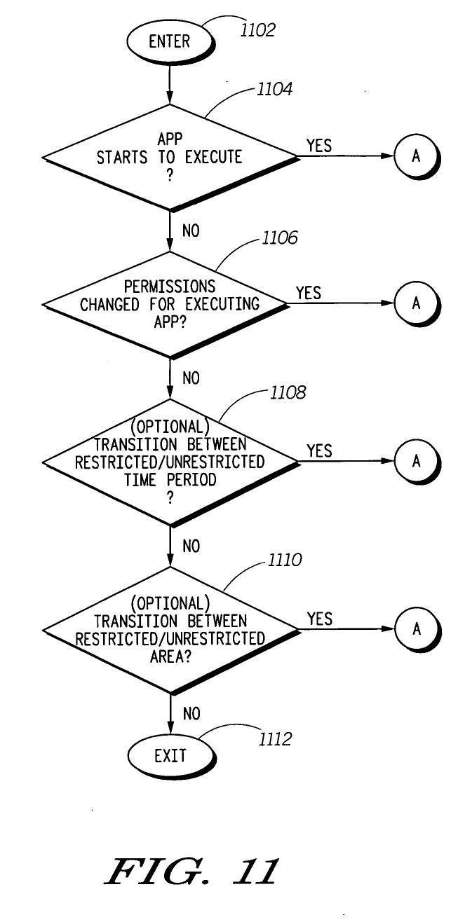

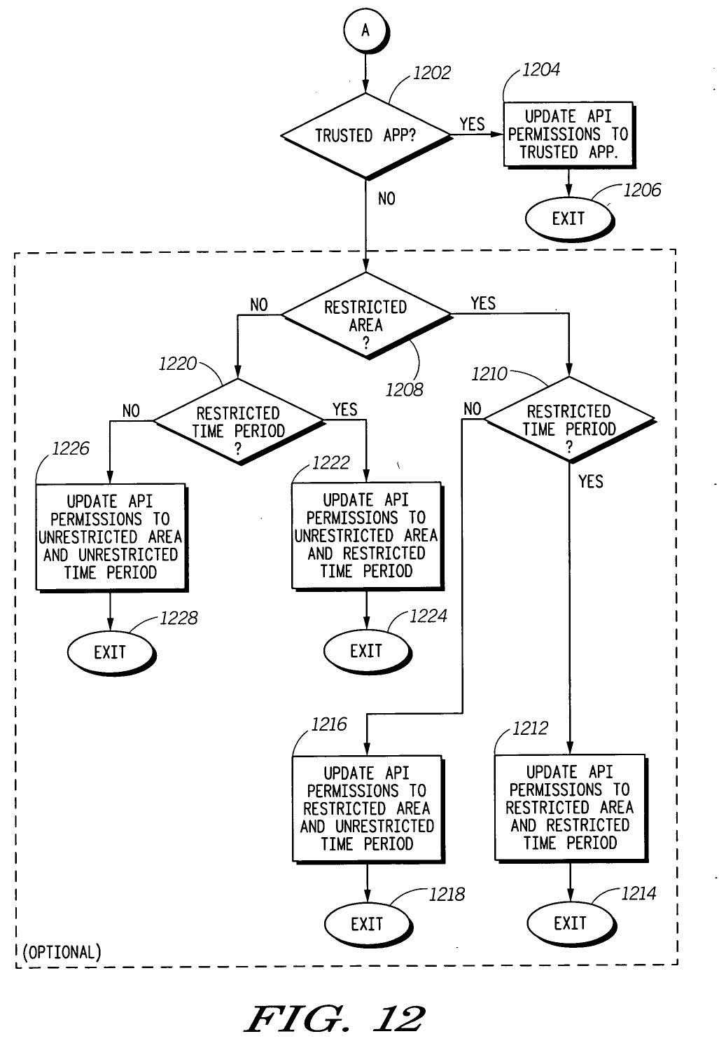

Referring to FIG. 11 and FIG. 12, these operational flow diagrams illustrate dynamic adjustment of the permissions associated with an application residing on the wireless device 104 according to an exemplary embodiment of the present invention. The operational flow diagram of FIG. 11 shows the initial process of how the device controller 202 by one of its sub-components, for example, the device permissions control module 112, decides whether the interface permissions associated with the application need to be dynamically adjusted. FIG. 12 shows the overall process of dynamically adjusting the interface permissions associated with an application after the initial steps are completed in FIG. 11. The operational flow diagram of FIG. 11 begins with step 1102 and flows directly to step 1104.

The device permissions control module 112, at step 1104, determines whether an application is executing. If this determination is positive, the control flows to FIG. 12. If this result is negative, the control flows to step 1006. The device permissions control module 112, at step 1006, determines whether the permissions have changed for the executing application. A change in permissions may occur, for example, when the permissions record associated with the application changes as a result of the flow diagram in FIG. 10. The device permissions control module 112 refers to the application information table 322 to determine whether the permissions have changed for the executing application. If the result of this determination is positive, the control flows to FIG. 12. If the result of this determination is negative, the control flows to step 1108

The device permissions control module 112, at optional step 1108, determines whether a transition between the restricted/unrestricted time periods has occurred. The device permissions control module 112 determines whether a transition has occurred by referring to the context information table (not shown) discussed above with reference to FIG. 4. If the result of this determination is positive, the control flows to FIG. 12. If the result of this determination is negative, then control flows to step 1110.

The device permissions control module 112, at optional step 1110, determines whether a transition between a restricted/unrestricted geographic area has occurred. The device permissions control module 112 determines whether a transition has occurred by referring to the context information table (not shown) discussed above with reference to FIG. 4. If the result of this determination is positive, the control flows to FIG. 12. If the result of this determination is negative, then control flows to step 1112 and exits this operational sequence.

Determining whether a transition has occurred between restricted/unrestricted time periods or geographic areas, at steps 1106, 1108, is optional because the present invention is not limited to using these operational environment identifiers. For example, in another embodiment of the present invention, only the status of the time period or geographic area might be used in combination with other information when dynamically adjusting an interface permission associated with an application.

Referring now to FIG. 12, the device permissions control module 112, at step 1202, determines whether the security level of the application is trusted. The device controller 202 does a look-up in the application information table 322 and finds the entries associated with the application. For example, if the application in step 1202 is a camera application, the device controller 202 locates the application entry 510 under the application field 502 in the application information table 322. The device controller 202 then locates the security level entry 514 for the camera application under the security level field 506 to determine the security level of the camera application. If the result of this determination is positive, then control flows to step 1204. If the result of this determination is negative, then control flows to step 1208.

The device permissions control module 112, at step 1204, dynamically updates the API permissions to trusted application. Once the device permissions control module 112 determines that the application is trusted, the device controller 202 updates, for example the flags (not shown) in the API shadow registers 802, 804 to the interface access permissions for a trusted application. The control flow, at step 1206, then exits.

The device permissions control module 112, at step 1208, determines whether the geographic area that the wireless device is currently operating in is restricted. The context information table (not shown), as discussed above with reference to FIG. 4, includes a geographic area entry that identifies the current status of the geographic area. For example, if the geographic area is currently a research lab or public bathroom, the geographic area may be classified as restricted. The device permissions control module 112 then refers to context information table (not shown) and determines whether the geographic area is restricted. If the result of this determination if positive, the control flows to step 1210. If the result of this determination is negative, the control flows to step 1220.

The device permissions control module 112, at step 1210, determines whether the wireless device 104 is currently operating within a restricted time period. The context information table (not shown), as discussed above with reference to FIG. 4, includes a time period entry that identifies the status of the current time period. For example, if the time period is currently during working hours it may be classified as restricted. The device permissions control module 112 then refers to context information table and determines whether the time period is restricted. If the result of this determination is positive, the control flows to step 1212. If the result of this determination is negative, the control flows to step 1216.

The device permissions control module 112, at step 1212, dynamically updates the API permissions to restricted area and restricted time period. Once the device permissions control module 112, at steps 1208, 1210 respectively, determines that the geographic area and time period are restricted, at steps 1208, 1210 respectively, refers to the permissions record that is associated with the application, for example permissions record1 326. The device permissions control module 112 locates the restricted time period/geographic area interface access permissions under the corresponding field 406 for each API. The device permissions control module 112 proceeds to dynamically update, for example, the flags (not shown) in the API shadow registers 802, 804. The control flow, at step 1214, then exits.

The device permissions control module 112, at step 1216, dynamically updates the API permissions to restricted area and unrestricted time period. Once the device permissions control module 112, at step 1208 determines that the geographic area is restricted and determines, at step 1210, that the time period is unrestricted, the device permissions control module 112 refers to the permissions record that is associated with the application, for example permissions record1 326. The device permission control module 112 locates the unrestricted time period/restricted geographic area interface access permissions under the corresponding field 408 for each API. The device permissions control module 112 proceeds to dynamically update, for example, the flags in the API shadow registers 308, 310. The control flow, at step 1218, then exits.

The device permission control module 112, at step 1220, also determines whether the time period is restricted, similar to step 1210. If the result of this determination is positive, the control flows to step 1222. If the result of this determination is negative, the control flows to step 1226.

The device permissions control module 112, at step 1222, dynamically updates the API permissions to unrestricted area/restricted time period. Once the device permissions control module 112, at step 1208, determines that the geographic area is unrestricted and determines, at step 1222, that the time period is restricted, the device permissions control module 112 refers to the permissions record that is associated with the application, for example permissions record1 326. The device controller 202 locates the restricted time period/unrestricted geographic area interface permissions under the corresponding field 410 for each API. The device permissions control module 112 proceeds to dynamically update, for example, the flags in the API shadow registers 802, 804. The control flow, at step 1224, then exits.

The device permissions control module 112, at step 1226, updates the API permissions to unrestricted area/unrestricted time period. Once the device permissions control module 112, at step 1208 determines that the geographic area is unrestricted and determines, at step 1220, that the time period is also unrestricted, the device permissions control module 112 refers to the permissions record that is associated with the application, for example permissions record1 326. The device permissions control module 112 locates the unrestricted time period/unrestricted geographic area interface permissions under the corresponding field 404 for each API. The device permissions control module 112 then proceeds to dynamically update, for example, the flags in the API shadow registers 802, 804. The control flow, at step 1228, then exits.

The steps 1208 through 1228 are optional steps and the present invention is not limited to these steps. For example, in another embodiment of the present invention, only the status of the time period or geographic area might be used in combination with other information when dynamically adjusting the interface access permissions associated with an application. In an alternative embodiment, the entire dashed box optional operational sequence may be replaced with the step of updating API permissions to UNTRUSTED Application.

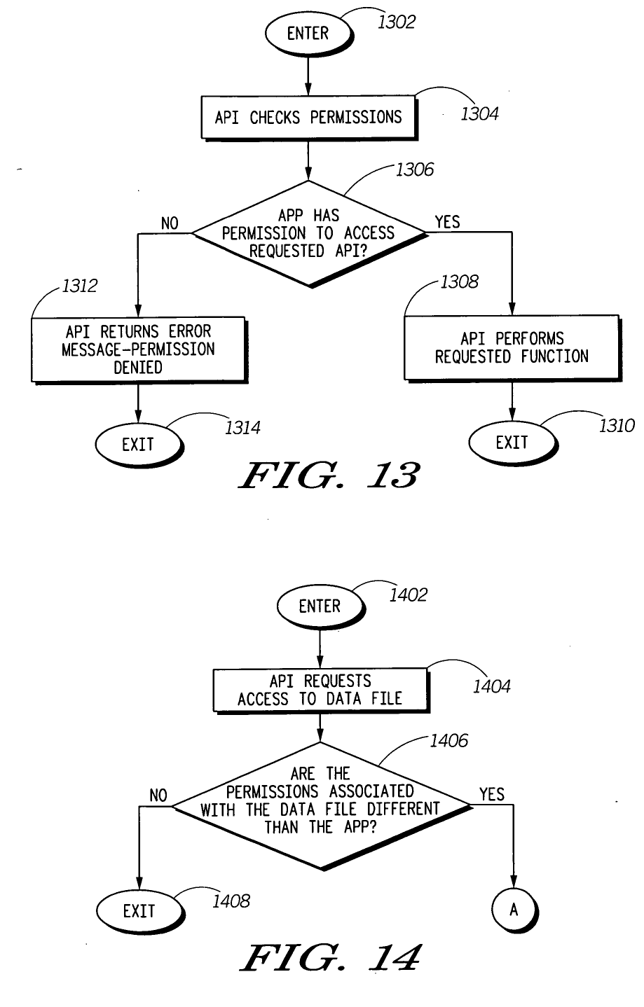

Referring to FIG. 13, an operational flow diagram showing the API access request process of an exemplary embodiment of the present invention is illustrated. The operational flow diagram of FIG. 13 shows an overall process taken after an application calls an API and the interface permissions associated with the application are checked. The operational flow diagram begins with step 1302 and flows directly to step 1304.

The API, at step 1304, checks the permissions that are associated with it. When an application executes, it requests permissions to various APIs, for example, API1 308 and API2 310. As a result of the steps described in FIG. 12, the shadow registers 802, 804 associated with API1 308 and API2 310 are dynamically updated with the interface access permissions for each API function, 312, 314, 316, 318, 320. The APIs 308, 310 request a permission response from their respective shadow registers 802, 804.

The shadow registers 802, 804 signal their corresponding API as to the current permission status and the application, at step 1306, determines whether it has permission to access the requested API. If the result to this determination is positive, the control flows to step 1308. If the result to this determination is negative, the control flows to step 1312. The requested API, at step 1308, performs the requested function. The control then flows to step 1310 and exits. The API, at step 1312, returns an error message back to the application stating that permission was denied to the requested API. The control then flows to step 1314 and exits.

Alternatively, in another embodiment of the present invention, the operational flows as shown in FIGS. 9 through 12 can be implemented by the central server 108. The central device permissions control module dynamically updates the central permissions database 706, application information table 710 and the central event history log in accordance with the above steps. The central server transmits a signal (e.g., a permissions control signal) to the wireless device 104 and dynamically updates the interface access permissions associated with the applications residing on the wireless device 104.

Referring to FIG. 14, an operational flow diagram describing an exemplary embodiment for dynamically adjusting interface access permissions associated with an application is shown. The operational flow diagram of FIG. 14 shows an overall process for dynamically adjusting interface access permissions for an application that has different permissions than the application that created the data file it is trying to access. That is, when an application attempts to access stored application data, such as stored in memory 204 or in storage memory 206, the device 104 may dynamically adjust interface access permissions associated with the application. The operational flow diagram of FIG. 14 begins with step 1402 and flows directly into step 1404.

An application, at step 1404 requests access to a data file. For example, an email application requests access to a picture file in the storage memory 206. The device controller 202, by one of its sub-components, for example the device permissions control module 112, determines whether the interface access permissions associated with the application are different than the permissions associated with the data file. For example, a different application than the one that created the data file may request access and have different permissions. Alternatively, the same application that created the data may be requesting access to the data file. However, the application now has different permissions because they were changed by a system administrator or the wireless device is operating in a different time period/geographic area.

The data file includes a pointer (i.e., it is linked) to the event history log 324. That is, the stored application data is linked to the history log 324. The device permission controller 112 locates the event history record that the data file is pointing to and processes the information. For example, if the picture image file in the example above has a pointer to the event record1 602 in the event history log 324; the device permission control module processes the information for that record. The device permission control module 112 then compares the permission information for the application requesting access with the permissions associated with the picture image file at the time it was created. In summary, time information and permission information in the history log is linked with stored application data (i.e., a data file) to represent permission for an application having access to the stored application data. The permission information is used by the device permission control module 112 for controlling the application's access to at least one application interface of the wireless device 104.

For example, the device permission control module 112 finds the permissions record the application was pointing to and the restricted/unrestricted status of the time period and geographic area at the time the application was created. The device permissions control module 112 determines whether any of this information is different than the same category of information in the application information table 322 for the requesting application. If the result of this determination is positive, the control flows to sub-part A shown in FIG. 12. If the result of this determination is negative, the control flows to step 1408 and exits.

Referring to FIG. 15, an operational flow diagram that illustrates another embodiment for dynamically adjusting the interface access permissions associated with an application on a wireless device is illustrated. The operational sequence of FIG. 15 shows an overall process for sending a remote security signal (or permission control signal) to the wireless device for dynamically adjusting the permissions. The operational sequence beings with step 1502 and flows directly into step 1504.

The device controller 202 by one of its sub-components, for example, the device permissions control module 112, at step 1502, determines whether a remote security signal (or permissions control signal) has been received. A remote security signal (or permissions control signal) may be sent from the central server 108, a system administrator's wireless device, or the like. The remote security signal (or permissions control signal), for example, may include any combination of a GPS signal, and RF signal, a wireless message, or the like. The remote security signal (or permissions control signal), for example, is received by the wireless device 104 via the GPS module 244, the local wireless link transmit receive module 218, or the receiver 208. If the result of the determination, at step 1504, is positive, the control flows to step 1506. If the result of the determination, at step 1504, is negative, the control flows to step 1510 and exits.

The device permissions control module 112, at step 1506, dynamically updates the interface permissions according to the remote security signal (or permissions control signal). The signal includes, for example, a new security level (or new application interface permissions) for the application, and the corresponding steps in FIG. 12 are performed. For example, if the remote security signal (or permissions control signal) contains information to dynamically update an application to trusted, step 1202 is entered into by the device permissions control module 112.

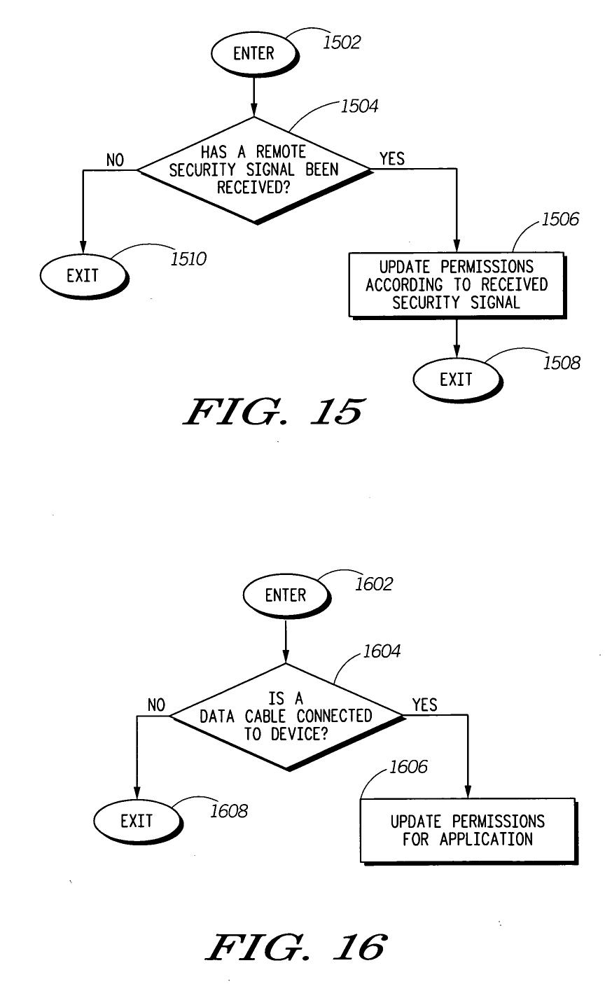

Referring to FIG. 16, an operational diagram that describes another embodiment for dynamically adjusting interface access permissions associated with an application is shown. The operational diagram of FIG. 16 shows an overall process for dynamically adjusting permissions associated with an application when a data cable is connected to the wireless device 104. The operation flow diagram begins with step 1602 and flows directly into step 1604.

The device controller 202 by one of its sub-components, for example, the device permissions control module 112, at step 1602, determines whether a data cable is attached to the wireless device 104. If the result of this determination is positive, the control flows to step 1606. If the result of this determination is negative, the control floes to step 1608 and exits.

The device permissions control module 112, at step 1606, dynamically updates the interface access permissions for the applications residing on the wireless device 104. Specific permissions may be set for when the data cable is attached (i.e., causing a detection of a permissions control signal) to the wireless device 104. For example, when a data cable is attached, applications are denied access to APIs that allow them to transfer data files over any network. Alternatively, when a data cable is attached, permissions may be determined on the time period/geographic area status of the wireless device 104. For example, if a data cable is attached and the wireless device 104 is operating during a restricted time period, data may only be transferred to certain network computers. Other ways of controlling interface permissions for an application in an electronic device, such as a wireless device 104, should be obvious to those of ordinary skill in the art in view of the present discussion.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for dynamically managing application interface permission for an application in a wireless device, the method comprising:
determining an initial security level for an application in a wireless device;
associating, in the wireless device, a security policy with the application, the security policy indicating permission for the application to access at least one application interface of the wireless device, wherein the security policy is based on the determined security level for the application in the wireless device; and
dynamically adjusting, in the wireless device, the security policy for the application based on detecting at least one permission control signal associated with the application.

2. The method of claim 1, further comprising:
creating a history log associated with the application, wherein the history log includes time information associated with permission information, the permission information indicating permission for an application to have access to the at least one application interface.

3. The method of claim 2, wherein the time information and permission information in the history log is linked with stored application data to represent permission for an application having access to the stored application data, the permission for controlling the application's access to at least one application interface of the wireless device.

4. The method of claim 3, wherein the dynamically adjusting comprises:
determining a security policy for an application based on detecting that the application is requesting access to stored application data that is linked with a history log having time information associated with permission information.

5. The method of claim 4, wherein the at least one application interface comprises an API for an operating system environment for the wireless device.

6. The method of claim 1, wherein the detecting the at least one permission control signal comprises at least one of:
detecting a transition for the wireless device between a restricted area and an unrestricted area;
detecting a transition for the wireless device between a restricted time and an unrestricted time;
detecting that an application is requesting access to stored application data;
detecting whether an interface cable is connected to the wireless device; and
receiving a wireless communication signal from a central server.

7. The method of claim 1, wherein the dynamically adjusting comprises detecting the at least one permission control signal corresponding to receiving a wireless message from a central server.

8. The method of claim 1, wherein the application comprises a camera application, and wherein the security policy indicating permission for the camera application to access at least one API of the wireless device.

9. An electronic device comprising:
a device controller, electrically coupled to the memory;
an application interface, electrically coupled to the device controller;
an application interface permissions database, electrically coupled to the device controller, wherein the device permissions database comprises interface access permission information associated with at least one application; and
a device permissions control module, electrically coupled to the device controller and the application interface permissions database, for dynamically adjusting a security policy for at least one application in the device in response to detecting at least one interface permission control signal associated with the at least one application, the security policy indicating permission for the at least one application to access at least one application interface in the electronic device.

10. The electronic device of claim 9, wherein the at least one application interface comprises an API for an operating system environment for the electronic device.

11. The electronic device of claim 9, wherein the device permissions control module for dynamically adjusting a security policy for at least one application in the electronic device in response to detecting at least one interface permission control signal comprising at least one of:
detecting a transition for the wireless device between a restricted area and an unrestricted area;
detecting a transition for the wireless device between a restricted time and an unrestricted time;
detecting that an application is requesting access to stored application data;
detecting whether an interface cable is connected to the wireless device; and
receiving a wireless communication signal from a central server.

12. The electronic device of claim 9, further comprising a wireless communication receiver for receiving wireless communications from a wireless network, and wherein the device permissions control module for dynamically adjusting a security policy for at least one application in the electronic device in response to detecting at least one interface permission control signal corresponding to receiving a wireless message from a central server.

13. The electronic device of claim 12, wherein the electronic device comprises at least one of a cellular telephone, a smartphone, a two-way radio, a wireless device, and a wireless messaging device.

14. The electronic device of claim 9, further comprising:
a history log for storing time information associated with permission information, the permission information indicating permission for an application to have access to the at least one application interface at a time represented by the associated time information.

15. The electronic device of claim 14, wherein the time information and associated permission information in the history log is linked with stored application data to represent permission for an application having access to the stored application data, the permission for controlling the application's access to at least one application interface of the electronic device.

16. The electronic device of claim 15, wherein the device permissions control module for dynamically adjusting a security policy for an application in the electronic device in response to detecting that the application is requesting access to stored application data that is linked with a history log having time information associated with permission information.

17. A wireless communications system comprising:
a central server communicatively coupled to a communications network;
at least one wireless device communicatively coupled to the communications network, wherein the at least one wireless device comprises a device permissions database and a device permissions control module;
a central permissions database communicatively coupled to the central server and to the device permissions database in the at least one wireless device, wherein the central permissions database comprises application interface access permission information for at least one application in the at least one wireless device; and
a central permissions control module communicatively coupled to the central server, the central permissions database, and the device permissions control module, for dynamically adjusting a security policy associated with the at least one application in the at least one wireless device, the security policy for controlling permission for the at least one application accessing an application interface of the at least one wireless device.

18. The wireless communications system of claim 17, wherein the central permissions control module for dynamically adjusting a security policy associated with the at least one application in the at least one wireless device by transmitting a wireless message from the central server into the communications network, the wireless message being destined for reception by the at least one wireless device.

19. The wireless communications system of claim 17, wherein the application interface comprises an API for an operating system environment for the at least one wireless device.
